(19) United States
(12) Patent Application Publication
(10) Pub. No.: US 2026/0219829 A1
(43) Pub. Date: Jul. 30, 2026

(54) DISPLAY APPARATUS AND SCREEN MIRRORING PLAYBACK RESUMING METHOD

(71) Applicant: HISENSE VISUAL TECHNOLOGY CO., LTD., Shandong (CN)

(72) Inventors: Jingkun ZHANG, Shandong (CN); Chunping ZHOU, Shandong (CN); Meiyu LIU, Shandong (CN); Xiujuan PANG, Shandong (CN); Guanghai ZHUANG, Shandong (CN); Liying LIU, Shandong (CN)

(21) Appl. No.: 19/578,407

(22) Filed: Mar. 25, 2026

Related U.S. Application Data
(63) Continuation of application No. PCT/CN2024/113671, filed on Aug. 21, 2024.

(30) Foreign Application Priority Data
Dec. 15, 2023 (CN) 202311734403.4

(51) Int. Cl. G06F 3/14; H04N 21/472; H04N 21/485; H04N 21/858

(52) U.S. Cl. CPC G06F 3/1454; H04N 21/47217; H04N 21/485; H04N 21/8586

(57) ABSTRACT

A display apparatus includes at least one processor, configured to: in response to a resume playback command for playing a cast screen exited last time, obtain playback resumption information of the cast screen; the playback resumption information being information recorded when a playback of the cast screen was exited last time, and the playback resumption information including a casting protocol type, a media asset playback address, media asset playback progress at a time the cast screen was exited last time, and playback effect information set for the cast screen by the user; create a virtual session based on the playback resumption information; obtain casting data from the media asset playback address through the virtual session; determine a playback start time for the casting data according to the media asset playback progress, and play the casting data from the playback start time based on the playback effect information.

### CROSS REFERENCE TO RELATED APPLICATIONS

This disclosure is a continuation application of PCT Application No. PCT/CN2024/113671, filed on August 21, 2024, which claims priority to Chinese Patent Application No. CN 202311734403.4, filed to the China National Intellectual Property Administration on December 15, 2023, the entire contents of which are incorporated herein by reference.

### TECHNICAL FIELD

The disclosure relates to the technical field of display apparatuses, and in particular, to a display apparatus and a method for resuming playing a cast screen.

### BACKGROUND

Display apparatuses are intelligent devices that can present user interfaces and support user interaction. Taking a smart TV as an example, the smart TV is a television product based on Internet application technology, equipped with an open operating system and chips, having an open application platform, capable of realizing two-way human-computer interaction functions, and integrating multiple functions such as video and audio, entertainment, and data, which is used to meet the diversified and personalized needs of users. A display apparatus can establish communication connections with a terminal device(s) such as a mobile phone, and obtain casting data from the terminal device(s) based on a specific casting protocol(s), so as to display a cast screen of terminal device(s) through the display apparatus.

Since the data source of the cast screen is provided or pushed by the terminal device when the display apparatus is displaying the cast screen, and the display apparatus and the terminal device are two independent entities, the playback cannot be controlled in in a manner of conventional video playback. For example, in a process in which the display apparatus displays the cast screen through a casting playback interface, if the user controls the display apparatus to switch to other interfaces by pressing a return button on a remote controller, the display apparatus will disconnect the casting connection during the switching process and will no longer receive the casting data transmitted by the terminal device. Therefore, when the user controls the display apparatus to return to a state of displaying the cast screen, the display apparatus needs the terminal device to re-push the cast screen, and the user is required to manually fast-forward to the previous playback progress to resume playing the cast screen, which degrades the user experience.

### SUMMARY

In a first aspect, embodiments of the disclosure provide a display apparatus, including: a display configured to display a casting interface for a cast screen; a user input interface configured to receive commands from a user; a communication device configured to establish a casting connection with a terminal device; a memory configured to store computer instructions and data associated with the display apparatus; at least one processor connected with the display, the user input interface, the communication device and the memory, and configured to execute the computer instructions to cause display apparatus to perform: in response to a resume playback command for playing a cast screen exited last time, obtaining playback resumption information of the cast screen from the memory, the playback resumption information being information recorded when a playback of the cast screen was exited last time, the playback resumption information including a casting protocol type, a media asset playback address, media asset playback progress at a time the cast screen was exited last time, and playback effect information set for the cast screen by a user; creating a virtual session based on the playback resumption information, the virtual session being configured to, on behalf the terminal device that established a casting connection for the cast screen that was exited last time, establish a virtual casting connection with the display apparatus according to the casting protocol type; obtaining casting data from the media asset playback address through the virtual session without re-establishing a physical casting connection with the terminal device; determining a playback start time for the casting data according to the media asset playback progress, and playing the casting data on the display from the playback start time based on the playback effect information.

In a second aspect, the embodiments of the disclosure further provide a method for resuming playing a cast screen, including: in response to a resume playback command for playing the cast screen exited last time, obtaining playback resumption information of the cast screen from the memory, the playback resumption information being the information recorded when a playback of the cast screen was exited last time, the playback resumption information including a casting protocol type, a media asset playback address at a time the cast screen was exited last time, media asset playback progress, and playback effect information set for the cast screen by the user; creating a virtual session based on the playback resumption information, the virtual session being configured to, on behalf of a terminal device that established a casting connection for the cast screen that was exited last time, establish a virtual casting connection with a display apparatus according to the casting protocol type; obtaining casting data from the media asset playback address through the virtual session without re-establishing a physical casting connection with the terminal device; determining a playback start time for the casting data according to the media asset playback progress, and playing the casting data on the display from the playback start time based on the playback effect information.

### BRIEF DESCRIPTION OF FIGURES

FIG. 1 is a schematic diagram of an operation scenario between a display apparatus and a control device according to some embodiments.

FIG. 2 is a schematic diagram of a hardware configuration of a display apparatus according to some embodiments.

FIG. 3 is a schematic diagram of a hardware configuration of a control device according to some embodiments.

FIG. 4 is a schematic diagram of a software configuration of a display apparatus according to some embodiments.

FIG. 5 is a schematic diagram of mirroring screen casting according to some embodiments.

FIG. 6 is a schematic diagram of push screen casting according to some embodiments.

FIG. 7 is a schematic diagram of a process of recording playback resumption information according to some embodiments.

FIG. 8 is a schematic diagram of a process of generating playback resumption information based on a remaining duration according to some embodiments.

FIG. 9 is a schematic diagram of a casting playback start interface according to some embodiments.

FIG. 10 is a schematic diagram of a process of recording playback resumption information at a moment when an exit command is input according to some embodiments.

FIG. 11 is a schematic diagram of a playback function module according to some embodiments.

FIG. 12 is a schematic diagram of a process of deleting playback resumption information according to some embodiments.

FIG. 13 is a schematic diagram of a process for resuming playing a cast screen according to some embodiments.

FIG. 14 is a schematic flowchart of resuming playing a cast screen through a virtual session according to some embodiments.

FIG. 15 is a schematic flowchart of resuming playing a cast screen based on application type according to some embodiments.

FIG. 16 is a schematic flowchart of resuming playing a cast screen for a second type of application according to some embodiments.

### DETAILED DESCRIPTION

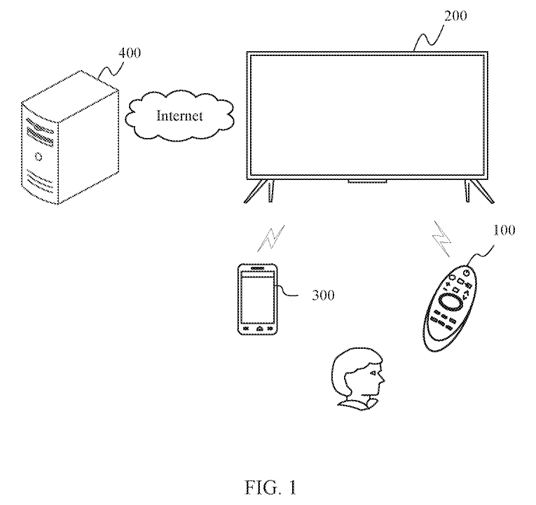

FIG. 1 is a schematic diagram of an operation scenario between a display apparatus and a control device according to some embodiments. As shown in FIG. 1, a user may operate a display apparatus 200 through touch operation, a mobile terminal 300 and a control device 100. The control device 100 may be a remote controller, a stylus pen, etc.

In some embodiments, the mobile terminal 300 may install software applications with the display apparatus 200, and achieve connection and communication through a network communication protocol to achieve the purpose of one-to-one control operation and data communication. The audio and video content displayed on the mobile terminal 300 may also be transmitted to the display apparatus 200 to achieve a synchronous display function.

As shown in FIG. 1, the display apparatus 200 also communicates data with a server 400 through various communication methods. The display apparatus 200 may be allowed to perform the communication and connection through a local area network (LAN), a wireless local area network (WLAN), and other networks.

In addition to providing a broadcast receiving television function, the display apparatus 200 may also provide an intelligent network television function with computer support functions, including but not limited to a network television, a smart television, an Internet Protocol television (IPTV), etc.

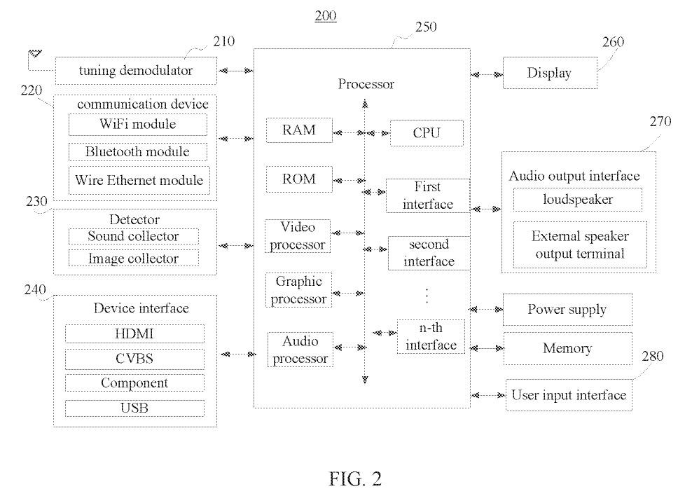

FIG. 2 is a block diagram of a hardware configuration of a display apparatus according to some embodiments. As shown in FIG. 2, the display apparatus 200 may include at least one of a tuning demodulator 210, a communication device 220, a detector 230, a device interface 240, at least one processor 250, a display 260, an audio output interface 270, a memory, a power supply, and a user input interface.

In some embodiments, the detector 230 may be used to collect external environment or signals for interacting with the outside. For example, the detector 230 includes a light receiver, a sensor for collecting the intensity of ambient light; or, the detector 230 includes an image collector, such as a camera, which can be used to collect external environment scenes, user attributes or user interaction gestures; or, the detector 230 includes a sound collector, such as a microphone, etc., for receiving external sounds.

In some embodiments, the display 260 may include a display screen component for presenting images, and a driving component for driving image display. The display is configured to receive image signals output from a processor to display video content, image content and components of a menu control interface, a user control user interface (UI), etc.

In some embodiments, the communication device 220 is a component for communicating with an external device or the server 400 according to various types of communication protocols. The display apparatus 200 may be provided with a plurality of communication devices 220 according to different communication modes it supports. For example, when the display apparatus 200 supports wireless network communication, the display apparatus 200 may be provided with a communication device 220 with a WiFi function. When the display apparatus 200 supports Bluetooth connection communication, the display apparatus 200 needs to be provided with a communication device 220 with a Bluetooth function.

The communication device 220 may enable the display apparatus 200 to communicate with the external device or the server 400 by wireless or wired connection. Among them, the wired connection may be a connection of the display apparatus 200 with an external device through a component such as a data line(s) and an interface(s). The wireless connection may be a connection of the display apparatus 200 with an external device through a wireless signal(s) or a wireless network(s). The display apparatus 200 may establish a connection with the external device directly, or indirectly establish a connection through a gateway, a router, a connection device, etc.

In some embodiments, the display apparatus 200 may also support establishing a communication connection with multiple external devices at the same time. The multiple external devices may be of the same type. For example, the external device is a terminal device 500 such as a mobile phone or a tablet computer. A first terminal device 510 and a second terminal device 520 may establish a communication connection with the display apparatus 200 by accessing the wireless local area network where the display apparatus 200 is located. The multiple external devices may also be connected to the display apparatus 200 through different types of connection methods. For example, the first terminal device 510 is connected to the display apparatus 200 via a wireless local area network; the second terminal device 520 is connected to the display apparatus 200 via Bluetooth.

In order to realize the communication connection between the display apparatus 200 and the terminal device 500, communication devices supporting the same communication type are provided in the display apparatus 200 and the terminal device 500, respectively. For example, when the display apparatus 200 is provided with a communication device 220 including a WiFi module, the terminal device 500 should also be provided with a communication device including a WiFi module. In addition, when the communication devices with the same communication type are provided, a specific communication transmission protocol is also required between the display apparatus 200 and the terminal device 500 for data transmission. For example, a WiFi protocol, a Bluetooth connection protocol, a ZigBee protocol, an NFC protocol, etc.

In some embodiments, the processor 250 may include a video processor, an audio processor, a graphics processor, a RAM, a ROM, and a first interface to an n^{th} interface for input/output. The processor 250 controls the operation of the display apparatus and responds to the user's operation through various software control programs stored in the memory. The processor 250 controls the overall operation of the display apparatus 200.

In some embodiments, the processor 250 and the tuning-demodulator 210 may be located in different separate devices, that is, the tuning-demodulator 210 may also be located in an external device of a main device where the processor 250 is located, such as an external set-top box.

In some embodiments, the user may input a user command in a graphical user interface (GUI) displayed on the display 260, and the user input interface receives the user input command through the graphical user interface (GUI).

In some embodiments, the user interface 280 is an interface that can be used to receive control input.

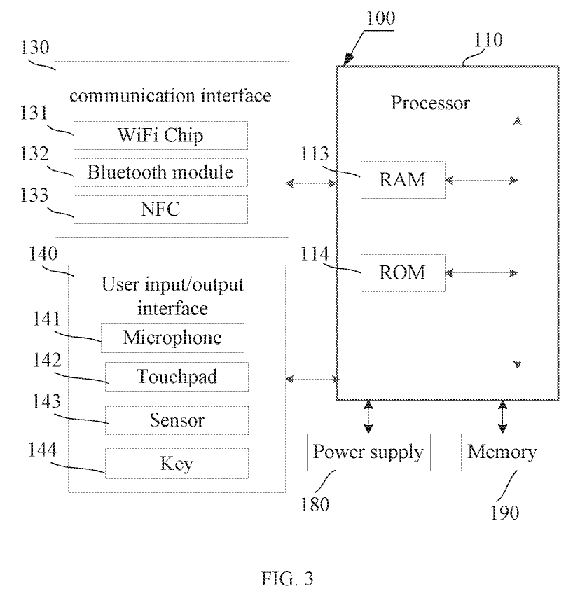

FIG. 3 is a block diagram of a hardware configuration of a control device according to some embodiments. As shown in FIG. 3, the control device 100 may include a processor 110, a communication interface 130, a user input/output interface, a memory, and a power supply.

The control device 100 may be configured to control the display apparatus 200, and may receive an operation command input from the user, and convert the operation command into an instruction that the display apparatus 200 can recognize and respond to, thereby playing the role of an interaction medium between the user and the display apparatus 200.

In some embodiments, the control device 100 may be a smart device, for example, the control device 100 may be installed with various applications for controlling the display apparatus 200 according to user requirements.

In some embodiments, as shown in FIG. 1, the mobile terminal 300 or other intelligent electronic device may perform similar functions as the control device 100 after installing an application for operating the display apparatus 200.

The processor 110 may include a RAM 113 and a ROM 114, a communication interface 130, and a communication bus. The processor 110 may be configured to control the operation of the control device 100, as well as the communication and cooperation between internal components and the data processing function between the outside and the inside.

Under the control of the processor 110, the communication interface 130 may realize the communication of control signals and data signals with the display apparatus 200. The communication interface 130 may include at least one of a WiFi chip 131, a Bluetooth module 132, an NFC module 133 and other near-field communication modules.

The user input/output interface 140, where the input interface includes at least one of a microphone 141, a touch pad 142, a sensor 143, a button 144, or other input interfaces.

In some embodiments, the control device 100 includes at least one of a communication interface 130 and an input/output interface 140. The control device 100 is configured with a communication interface 130, such as modules for WiFi, Bluetooth, NFC, etc., which can encode user input commands through the WiFi protocol, Bluetooth protocol, or NFC protocol, and send them to the display apparatus 200.

The memory 190 may be used to store various operating programs, data and applications for driving and controlling the control device 100 under the control of the processor. The memory 190 may store various control signal commands input from the user.

The power supply 180 may be used to provide operating power support for each component of the control device 100 under the control of the processor.

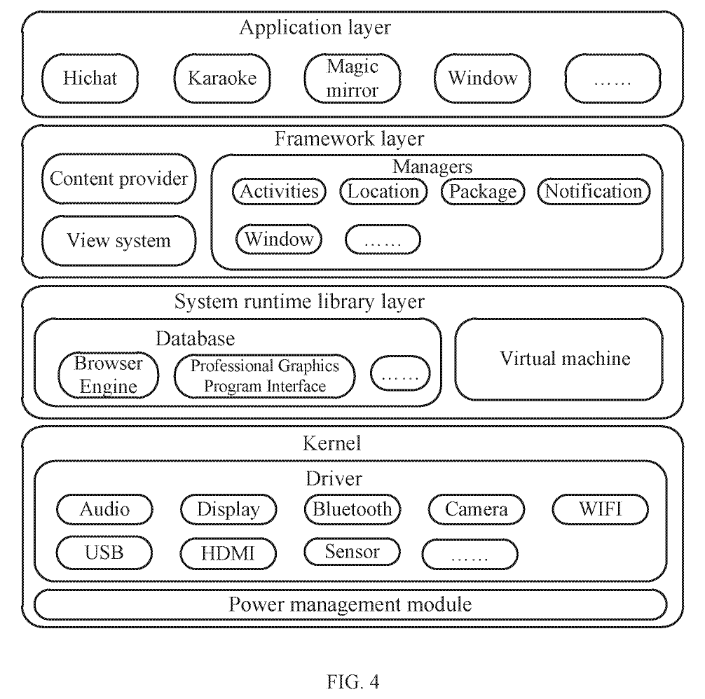

As shown in FIG. 4, in some embodiments, a system is divided into four layers, from top to bottom, namely, an application (Applications) layer (referred to as “application layer”), an application framework layer (referred to as “framework layer”), an Android runtime and system library layer (referred to as “system runtime library layer”), and a kernel layer.

In some embodiments, at least one application is running in the application layer, and the at least one application may be a window program, a system setting program, a clock program, etc. provided by an operating system, or an application(s) developed by a third-party developer(s). In a specific implementation, application packages in the application layer are not limited to the above examples.

The framework layer provides an application programming interface (API) and a programming framework for an application. The application framework layer includes some predefined functions. The application framework layer is equivalent to a processing center that determines the actions that applications in the application layer take. The applications may access system resources and obtain system services during execution through the API interface.

As shown in FIG. 4, the application framework layer in the embodiments of the disclosure includes a view system, managers, a content provider, etc. The view system may design and implement an interface and interaction of an application. The view system includes lists, grids, text boxes, buttons, etc. The managers include at least one of the following modules: an activity manager for interacting with all activities running in the system, a location manager for providing system services or applications with access to system location services; a package manager for retrieving various information related to application packages currently installed on the device; a notification manager for controlling the display and clearing of notification messages; and a window manager for managing icons, windows, toolbars, wallpapers, and desktop widgets on the user interface.

In some embodiments, the activity manager is configured to manage a life cycle of each application and a common navigation back function, such as controlling the exit, opening, and back of the application. The window manager is used to manage all window programs, such as obtaining a size of a display screen, determining whether there is a status bar, locking the screen, capturing the screen, and controlling a display window changes, for example, reducing a size of the display window, shaking the display window, distorting the display window, etc.

In some embodiments, the system runtime library layer provides support for the upper layer, namely the framework layer. When the framework layer is used, the Android operating system will run the C/C++ library contained in the system runtime library layer to implement the functions to be implemented by the framework layer.

In some embodiments, the kernel layer is a layer between hardware and software. As shown in FIG. 4, the kernel layer includes at least one of the following drivers: an audio driver, a display driver, a Bluetooth driver, a camera driver, a WIFI driver, a USB driver, an HDMI driver, a sensor driver (such as a fingerprint sensor, a temperature sensor, a pressure sensor, etc.), and a power driver, etc.

After establishing a communication connection with the terminal device 500, the display apparatus 200 may establish a casting connection channel, and transmit the casting data based on the casting connection channel, so that the display apparatus 200 may display a cast screen of the terminal device 500. In some embodiments, in order to establish a casting connection, the user may send a casting connection request through the terminal device 500, and the casting connection request is sent to the display apparatus 200 through a WiFi network. The display apparatus 200 then completes a configuration of a transmission protocol according to the casting connection request, thereby establishing a transmission channel for the casting data with the terminal device 500.

The display apparatus 200 may also realize the casting connection with the terminal device 500 through different connection methods. For example, when the display apparatus 200 and the terminal device 500 are connected to the same wireless local area network, the casting connection may be established based on the WiFi network. For another example, when both the display apparatus 200 and the terminal device 500 are provided with a Near Field Communication (NFC) component, the casting connection may be established through the NFC component. Obviously, other wired or wireless connection methods may also be used between the display apparatus 200 and the terminal device 500 to establish the casting connection, such as an RF radio frequency connection, an infrared connection, a cellular network, and other connection methods that can be associated with those skilled in the art based on the connection methods provided in the above embodiments.

After the casting connection is established, the display apparatus 200 can receive casting related data of the terminal device 500 through a casting data channel, so as to play a casting related content in the display apparatus 200. Under different casting data transmission protocols, the casting data obtained by the display apparatus 200 is in different forms. For example, the display apparatus 200 and the terminal device 500 may establish a casting connection through protocols such as a Digital Living Network Alliance (DLNA) protocol, a Miracast protocol, an AirPlay push protocol, a WiDi casting, an NFC mirror casting, a lebocast and other.

The DLNA protocol is a protocol for sharing media resources between devices. The protocol uses network technology (wired or wireless) to interconnect various devices and exchange data through standard protocols, so that media resources can be shared between devices. The DLNA protocol is based on a UPnP protocol, which enables devices to discover and control each other and achieve seamless transmission and sharing of media resources. The DLNA protocol supports a variety of devices, including a TV(s), a speaker(s), a mobile phone(s), a computer(s), etc., allowing users to seamlessly switch and share media content between different devices.

The Miracast protocol is a wireless display standard developed by Wi-Fi Alliance based on Wi-Fi direct connection. The Miracast protocol is applicable to Android devices, that is, Android devices can share video images through Miracast casting. Smart devices with Android 5.0 and above have the Miracast protocol built-in, so that direct wireless casting can be achieved through the WiFi P2P function between a casting device and a WiFi network card of a receiving device without installing any software. In addition, Miracast casting also supports synchronous transmission of audio and video.

The Airplay protocol is a wireless playback technology launched by Apple Inc., serving as a wireless casting protocol applicable to iOS and Mac systems. Apple devices have a built-in Airplay casting function, which, when used with a casting device that supports AirPlay server service, delivers clear and stable performance. The protocol comes with a casting function. However, it is necessary to ensure that the Apple device and the casting device are used in the same local area network (same network segment), and cannot be used across network segments or VLANs.

The WiDi casting is a wireless playback technology led by Intel, which is also based on WiFi Direct technology. Windows 8/10/11 laptops natively support WiDi casting, enabling directly casting without installing any software, and also support a USB reverse control function.

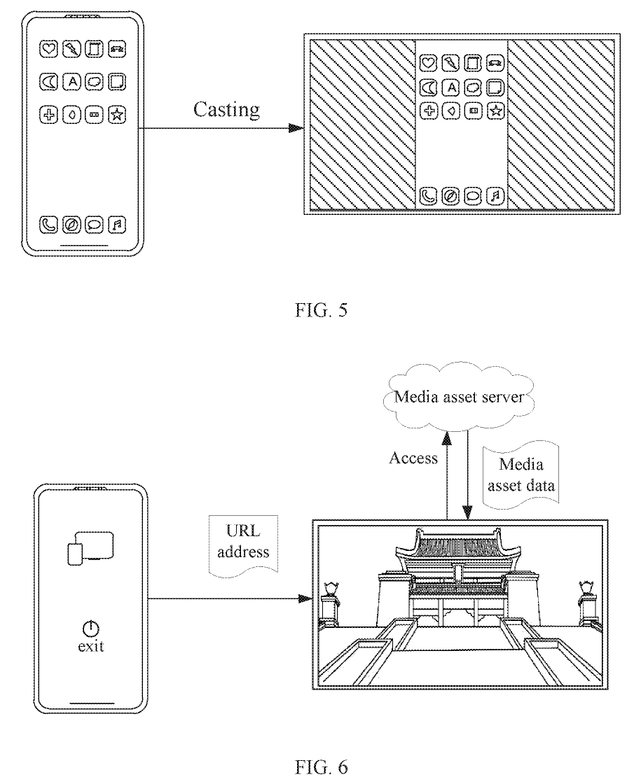

In some embodiments, after the display apparatus 200 establishes a casting connection with the terminal device 500, casting data may be transmitted through a mirroring mode and a push mode. The mirroring mode refers to the display apparatus 200 synchronously displaying image content displayed by the terminal device 500. For example, as shown in FIG. 5, the display apparatus 200 displays a main interface of the terminal device 500, and when the user performs an interactive operation on the terminal device 500, causing the content of the main interface to change, the content displayed by the display apparatus 200 also changes. To this end, the terminal device 500 may generate a casting data stream in the form of a video based on the displayed content, and send the casting data stream to the display apparatus 200 for display.

The push mode means that the display apparatus 200 obtains a corresponding cast screen by accessing a network link pushed by the terminal device 500. For example, as shown in FIG. 6, when the terminal device 500 plays video media assets, a casting control is provided in the upper right corner of a play interface. After the user clicks the casting control and selects the display apparatus 200 as the device for displaying the cast screen, the terminal device 500 may send the URL address of the video media assets currently playing to the display apparatus 200. After receiving the URL address, the display apparatus 200 accesses the URL address to obtain video media asset data and plays the video media asset data.

In the casting protocols supported by the display apparatus 200 and the terminal device 500, some protocols are based on the mirroring mode, and some protocols are based on the push mode. For example, under the DLNA protocol, the display apparatus 200 may obtain a link address of a resource in the terminal device 500 through the casting data channel, and obtain the media asset content data by accessing the link address to play the media asset content data. At the same time, the display apparatus 200 may also obtain a control instruction sent by the terminal device 500 through the casting data channel when playing the media asset content data, such as fast-forward, pause, stop casting, etc. For example, after establishing a connection through a communication protocol, the terminal device 500 such as a mobile phone and the display apparatus 200 will negotiate the device functions and network conditions to select a suitable audio and video transmission format. After establishing an online protocol (Session) for audio and video streaming, a series of real-time streaming protocol (RTSP) control commands are used to control the playback and termination of the audio and video streaming.

Under other casting connection protocols such as Miracast casting, Airplay casting, NFC mirror casting, and lebocast, the display apparatus 200 may directly obtain a video data stream from the terminal device 500. The video data stream may be the video data stream corresponding to a display image finally displayed by a display unit of the terminal device 500, that is, the video data stream includes a media asset content image, a UI interface, and other video image content that can be displayed in the display unit of the terminal device 500. The video data stream may also be only the video data that can be obtained in the terminal device 500, such as the media asset video data being played. At this time, the terminal device 500 may be used as a signal source for the display apparatus 200, and the display apparatus 200 may continuously obtain video data through the casting data channel, and display it in real time on the display 260, so as to achieve the effect of synchronous display with the terminal device 500.

It should be noted that the above-mentioned casting protocols can not only obtain the video data stream in the terminal device 500, but also obtain an audio data stream in the terminal device 500, so that the video data and audio data may be sent to the display apparatus 200 synchronously, so that the display apparatus 200 can play the video and audio synchronously.

The terminal device 500 may obtain different casting data according to different casting protocols. For example, for system applications or casting directly performed at the system level, the terminal device 500 may use the Miracast casting protocol, the Airplay casting protocol or the WiDi casting protocol to establish a casting data channel. Since the above-mentioned Miracast casting protocol and Airplay casting protocol require system-level application permissions, the Miracast casting protocol and Airplay casting protocol are only applicable to system applications, or a display apparatus 200 and a terminal device 500 of the same manufacturer directly establishing a casting connection through the built-in rules of the operating system.

After the display apparatus 200 establishes a casting connection with the terminal device 500 based on any of the above casting protocols, a cast screen may be formed according to the casting data sent by the terminal device 500. The cast screen may be displayed through a specific user interface. In the embodiments of the disclosure, the user interface for displaying the cast screen may be referred to as a casting interface. It should be understood that the casting interface may be an independent interface. For example, the casting interface is a floating casting window. The casting interface may also be the playback interface of the display apparatus 200. For example, after the casting connection is established, when the display apparatus 200 displays the casting content in full screen, the entire full-screen displayed image content corresponds to the casting interface.

Since the data source of the cast screen is special, that is, the display apparatus 200 obtains the casting data from the terminal device 500 and then plays it to form the cast screen. Therefore, the playback control of the casting data by the display apparatus 200 is restricted by conditions such as the casting protocol and the terminal device 500, which places the display apparatus 200 in a passive playback mode and makes it difficult to complete control processes such as playback recording, adjustment, switching according to the media asset playback process.

For example, in the mirroring mode, the display apparatus 200 may only display a mirroring casting data stream sent by the terminal device 500 in real time, and the control of the casting process is limited to basic operations such as exit. In the push mode, the display apparatus 200 obtains the casting data by accessing a media asset playback address pushed by the terminal device 500. However, since the casting data is pushed by the terminal device 500, the data source is still the terminal device 500 by default. Therefore, after the display apparatus 200 exits the casting interface, it will directly disconnect the casting connection and will not record any playback data. If the user wants to resume playing the cast screen, it is necessary to re-establish a casting connection between the display apparatus 200 and the terminal device 500, and manually adjust the playback progress to the time of exiting through the fast-forward operation, and then resume the playback of the cast screen. It is evident that such a method for resuming the playback of the cast screen is cumbersome to operate and has long waiting time for resumption, which will reduce the user experience.

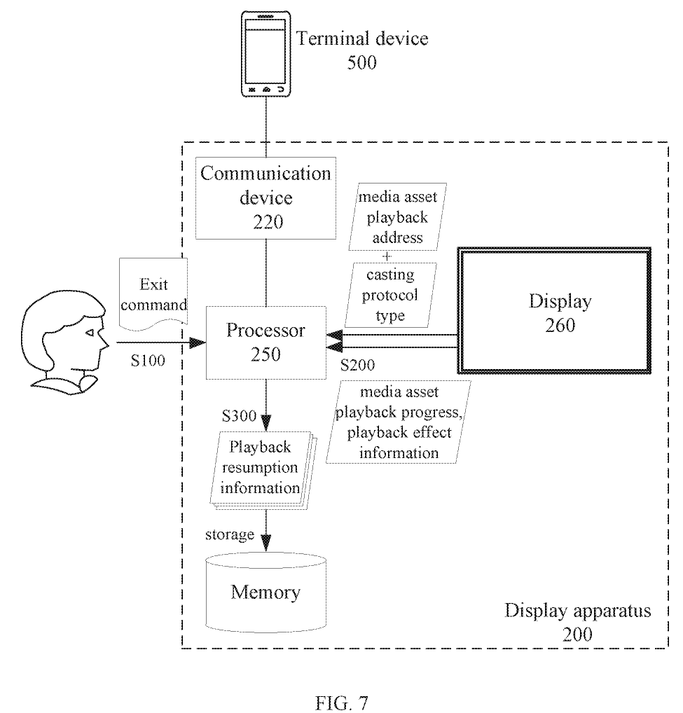

In order to solve the problem of inability to resume playback during casting, the embodiments of the disclosure provides a display apparatus 200. The display apparatus 200 can record the media asset playback progress when the casting is exited, generate playback resumption information, and automatically jump to the playback progress at the time of exiting according to the playback resumption information when the user chooses to resume playing the cast screen, to achieve the purpose of automatically resuming the playback of the cast screen. To meet the implementation of the above functions, the display apparatus 200 may include a display, a user input interface, a communication device, a memory, and at least one processor. The display 260 is configured to display a casting interface for a case screen, the user input interface is configured to receive commands from the user, the communication device is configured to establish a casting connection with the terminal device, the memory is configured to store computer instructions and data associated with the display apparatus, at least one processor is connected with the display, the user input interface, the communication device and the memory, and is configured to execute the computer instructions to cause the display apparatus to perform the steps corresponding to a method for resuming playing a cast screen, as shown in FIG. 7, the following steps are included.

S100: obtaining an exit command for exiting a casting interface.

In the embodiments of the disclosure, the exit command for exiting the casting interface may include two types, and the first type is an active exit command, that is, an exit command for the user to actively exit the casting interface through a specific interactive operation. For example, during the process of the display apparatus 200 displaying the casting interface, the exit command is generated when the user presses a return key on the remote controller equipped with the display apparatus 200 to control the display apparatus 200 to exit the casting interface.

In some embodiments, the user may input an exit command based on different interactive operations. For example, for a display apparatus 200 that supports touch interactive operations, when the display apparatus 200 displays the casting interface, the user may control the display apparatus 200 to exit the casting interface by performing an exit gesture of sliding upward from the bottom edge of the display 260. That is, the exit command may be input through touch interaction. For another example, for a display apparatus 200 that supports voice interactive operations, when the display apparatus 200 displays the casting interface, the user may input a voice such as "exit casting" to control the display apparatus 200 to exit the casting interface, that is, the exit command may be input through voice interaction.

The second type is a passive exit command, which is an exit command passively generated when the display apparatus 200 switches the display content from the casting interface to other interfaces according to an operating state or a user interaction action. For example, when the display apparatus 200 is displaying the casting interface, if the user plugs a game device into its HDMI port, the display apparatus 200 will automatically switch to a signal source setting interface. At this point, the display apparatus 200 may generate an exit command according to a plug-in signal.

According to an interface switching rule set by the operating system of the display apparatus 200, a passive exit command may be generated in different operating states, and the exit command may also be input or generated by the control device 100 or an external device. For example, when the user controls the display apparatus 200 to switch from the casting interface to a home interface by pressing the home button on the remote controller, the display apparatus 200 may generate and execute the exit command. For example, for a display apparatus 200 that supports video (or voice) calls, if a video call request is received when the display apparatus 200 is displaying the casting interface, the display apparatus 200 may also switch from the casting interface to a video call interface.

In the following description, unless otherwise specified, an exit command specifically refers to a passive exit command of the second type.

S200: in response to the exit command, recording a casting protocol type and a media asset playback address of the casting interface, and recording media asset playback progress at a moment when the exit command is input and playback effect information.

In order to obtain the casting protocol type, the display apparatus 200 may read a configuration file of the casting interface, and the configuration file may record the casting protocol used by the display apparatus 200 when establishing a casting connection with the terminal device 500. For example, when the user controls the display apparatus 200 to establish a casting connection with the terminal device 500 through the DLNA protocol default by the system, the display apparatus 200 will first create a configuration file when rendering the casting interface, and record DLNA protocol related fields in the configuration file. When recording the casting protocol type, the display apparatus 200 may call the configuration file again and read the DLNA protocol related fields from the configuration file, thereby recording that the type of the current casting protocol is the DLNA protocol.

In some embodiments, the display apparatus 200 may also determine the casting protocol type according to the casting data. Since different casting protocols may use different data formats and different compression algorithms for casting data, the casting protocol type may be determined by reading the data format and compression algorithm of the casting data. For example, the Miracast protocol uses WiFi Direct technology for data transmission, while the AirPlay protocol adopts Apple's proprietary data format for transmission. When the data transmission format conforms to WiFi Direct technology, the casting protocol type may be determined to be the Miracast protocol.

In some embodiments, the display apparatus 200 may also obtain and record the casting protocol type according to a casting application. For example, when the video application A is installed and run on both the display apparatus 200 and the terminal device 500, the user may click a casting control in the upper right corner of an interface of the video application A of the terminal device 500, and the terminal device 500 may establish a casting connection with the display apparatus 200 through the casting protocol supported by the video application A. Therefore, when recording the casting protocol type, the display apparatus 200 may determine that the current casting application is the video application A by reading the package name information of the casting application, and then query a casting protocol that is supported by or default for the video application A to obtain the casting protocol type.

While recording the casting protocol type, the display apparatus 200 may also record the media asset playback address. The media asset playback address may be obtained by reading a signal source address of a player. For example, after the display apparatus 200 establishes a casting connection with the terminal device 500, the terminal device 500 may send the URL address of the casting data to the display apparatus 200 by means of push casting. The display apparatus 200 sets the data source of the player according to the received URL address. Therefore, when recording the media asset playback address, the display apparatus 200 may directly read the data source of the player to obtain the media asset playback address.

Since the configuration file of the casting interface is created when the casting connection is established, the display apparatus 200 may also write the media asset playback address sent by the terminal device 500 into the configuration file when the configuration file is created. Therefore, in some embodiments, the display apparatus 200 may also obtain and record the media asset playback address by reading the configuration file.

While the casting protocol type and the media asset playback address are recorded based on the above embodiment, the display apparatus 200 may also record the media asset playback progress according to the input time of the exit command, that is, the media asset playback progress at the time when the exit command is input is recorded. Among them, the media asset playback progress may be expressed by the playback time or by a percentage. For example, the display apparatus 200 may obtain a start time T0 of the player playing the casting data and a total duration T1 of a media asset of the casting data according to a decoding result of the casting data, and then calculate the media asset playback progress based on the start time of the player, the total duration of the media asset of the casting data and the input time T of the exit command. When the media asset playback progress is represented by time, the display apparatus 200 may calculate a difference between the input time T and the start time T0, i.e., T-T0, to obtain the media asset playback progress. When the media asset playback progress is represented by a percentage, the display apparatus 200 may calculate a difference between the input time T and the start time T0, and then calculate the percentage of the difference to the total duration T1 of the media asset, that is, the media asset playback progress is equal to (T-T0) / T1.

In some embodiments, in addition to recording the casting protocol type, the media asset playback address and the media asset playback progress, the display apparatus 200 may also record other relevant information that facilitates the user to perform interactive operations, including user setting information and display content information. For example, in response to an exit command, the display apparatus 200 may also record a media asset ID (name, title, etc.), a thumbnail, and playback effect information such as speed, an audio track, a subtitle, and a zoom mode set by the user.

It should be noted that, for the display apparatus 200, the active exit command is actively input by the user, and may include the user's intention to actively stop casting. The passive exit command is caused by events such as unexpected operations, and therefore does not include the user's intention to actively stop casting. In the state where there is no intention to actively stop casting, the user is more likely to need to resume the playback of the cast screen. Therefore, in some embodiments, the display apparatus 200 may only record the playback resumption information when the passive exit command is received.

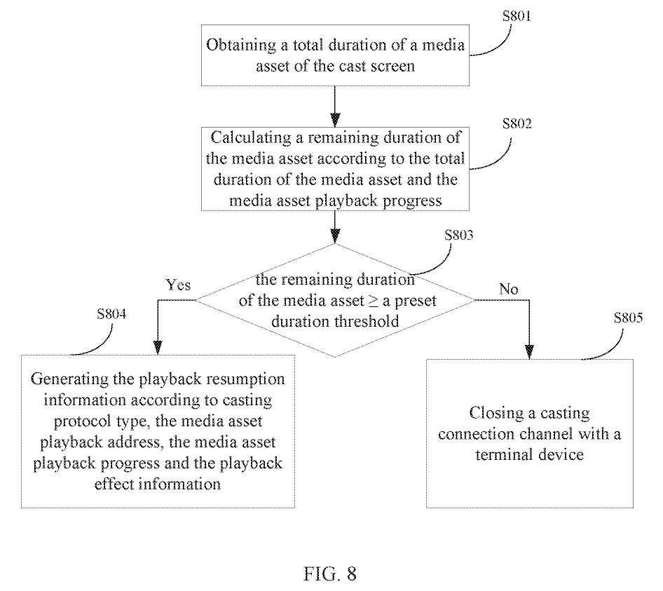

In a process of recording the media asset playback progress, the display apparatus 200 may also detect the media asset playback progress and a type of media asset to determine whether the media asset playback progress or the type of media asset supports resuming the playback of cast screen. For example, for video media asset such as movies, when the media asset playback progress is substantial and the main film has been played, resuming playback will only play the ending credits, which has little practical value for user, so it is not necessary to resume the playback of the cast screen, that is, the playback resumption information corresponding to the cast screen is not recorded. For another example, live broadcast videos do not have a fixed length and cannot be resumed, so playback resumption information corresponding to the cast screen may not be recorded. For this purpose, the playback resumption information may be generated according to the remaining duration through the process shown in FIG. 8. As shown in FIG. 8, the following steps are included.

S801: obtaining a total duration of a media asset of the cast screen.

S802: calculating a remaining duration of the media asset according to the total duration of the media asset and the media asset playback progress.

S803: determining whether the remaining duration of the media asset is greater than or equal to a preset duration threshold.

In response to the remaining duration of the media asset being greater than or equal to a preset duration threshold, S804: generating the playback resumption information according to the casting protocol type, the media asset playback address, the media asset playback progress and the playback effect information.

In response to the remaining duration of the media asset being less than a preset duration threshold, S805: closing a casting connection channel with a terminal device.

If the remaining duration of the media asset is greater than or equal to the preset duration threshold, it means that the remaining duration of the casting media asset is relatively long, and it is convenient for resuming the playback of the cast screen, then the display apparatus 200 may generate the playback resumption information according to the casting protocol type, the media asset playback address, the media asset playback progress and the playback effect information. If the remaining duration of the media asset is less than the preset duration threshold, it means that the remaining duration of the casting media asset is relatively short, and it is not convenient for resuming the playback of the cast screen, so the display apparatus 200 may directly close the casting connection channel with the terminal device 500.

For example, when the display apparatus 200 exits the casting interface, it can determine whether the video corresponding to the cast screen has been played or is a live video. If the remaining duration of the video is greater than 1 minute, it is determined that the current cast screen supports playback resumption. Therefore, the display apparatus 200 may record the media asset playback address and media asset playback progress, and generate playback resumption information. If the remaining duration of the video is less than 1 minute, it is determined that the current cast screen does not support playback resumption, so the display apparatus may exit the casting interface directly. When it is detected that the playback time (or remaining duration) is 0, it can be determined that the current cast screen is a live video and does not support playback resumption, so the display apparatus may also exit the casting interface directly.

S300: generating the playback resumption information according to the casting protocol type, the media asset playback address, the media asset playback progress, and the playback effect information.

After recording the casting protocol type, the media asset playback address, the media asset playback progress, and the playback effect information, the display apparatus 200 may convert the recorded information according to a preset data format to generate the playback resumption information.

In some embodiments, the display apparatus 200 may record and manage the playback resumption information through a specific application. That is, the display apparatus 200 is provided with a casting entry application, which is an application that provides a casting playback start interface. For example, the display apparatus 200 may save the information recorded in the above embodiments in the casting entry application through the Setting.Global process, so that the casting entry application may display the casting playback start interface.

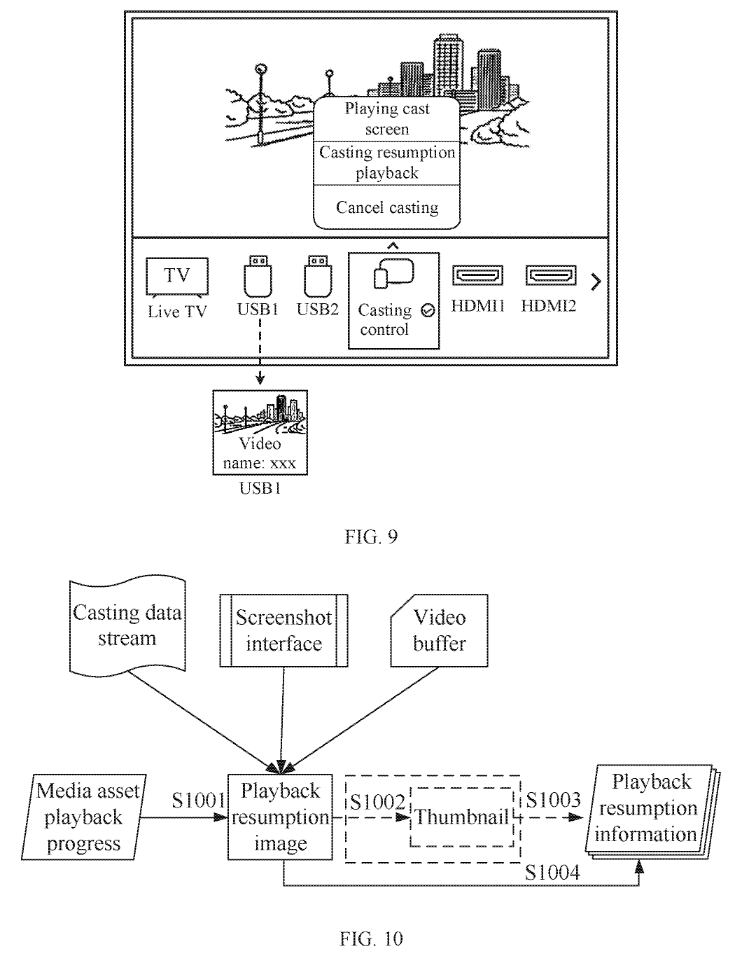

Since the casting process is equivalent to providing a casting signal source for the display apparatus 200, the casting playback start interface may be built into a signal source selection interface or be the same interface as the signal source selection interface. As shown in FIG. 9, in the casting playback start interface, multiple signal source options may be included, such as live TV signal source, HDMI port signal source, USB interface signal source, casting signal source, etc. In these signal source options, the signal source type may be displayed through view controls such as title text, icons, and thumbnails for users to choose.

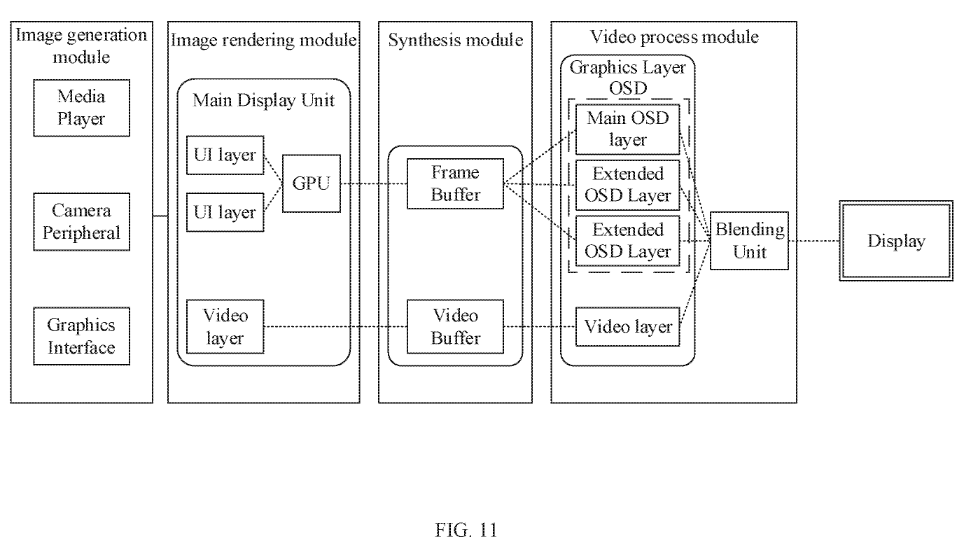

In some embodiments, the display apparatus 200 may record the casting protocol type, the media asset playback address, the media asset playback progress, and the playback effect information, and then record the content of the cast screen at the time when the exit command is input, i.e., the playback resumption information. When implemented, as shown in FIG. 10, the display apparatus 200 may generate a playback resumption image (S1001) according to the media asset playback progress, and perform compression processing on the cast screen to generate a thumbnail (S1002), and then add the thumbnail to the playback resumption information (S1003).

To help users quickly find the video they want to resume playing, a video name of a video corresponding to the signal source and a thumbnail corresponding to the playback resumption image generated according to the media asset playback progress of the video, such as the signal source option USB1 shown in FIG. 9 above, may also be added to the signal source option in the casting playback start interface.

In addition, considering that the thumbnail is the content displayed to the user through the above-mentioned signal source option, it is used to allow the user to quickly browse video images corresponding to the media asset playback progress through the thumbnail, rather than to tell the display apparatus how to perform a resumption function. Therefore, after the playback resumption image is generated through S1001, the playback resumption image may be directly added to the playback resumption information (S1004). That is, when the playback resumption information is recorded, the playback resumption image is not compressed to generate a thumbnail.

The playback resumption image is used to display the content of the cast screen at the time when the exit command is input. According to different image acquisition rules, the display apparatus 200 may obtain the playback resumption image in different ways. In some embodiments, the display apparatus 200 may extract the playback resumption image from the data stream of the cast screen, that is, the playback resumption image is an image frame extracted from the data stream of the cast screen according to the media asset playback progress. After the display apparatus 200 establishes a casting connection with the terminal device 500, the display apparatus 200 may obtain casting data based on the URL address sent by the terminal device 500 and form a casting data stream. The casting data stream includes multiple continuous image frames, each of which is provided with a timestamp for playback. The display apparatus 200 may record the input time of the exit command upon obtaining the exit command, read a timestamp of an image frame according to the input time, determine an image frame with the smallest time difference with the input time, and copy the image frame to generate the playback resumption image.

In some embodiments, the display apparatus 200 may capture a screenshot of the current casting interface by invoking a screenshot process to obtain a playback resumption image. That is, the playback resumption image is an image obtained by invoking the screenshot interface to capture the cast screen. For example, when the display apparatus 200 receives an exit command, it can call Android's developer API to call the screenshot process of the system. That is, the display apparatus 200 first calls the screenshot process through the instruction “import android.graphics.Bitmap; import android.graphics.Canvas; import android.view.View; import android.widget.ImageView”, and then obtains the view to be captured through the instruction “View viewToCapture=findViewById(R.id.view_to_capture)”;

Next, the display apparatus creates a Bitamp object and uses the Bitmap object as its bitmap. During implementation, a Bitmap object for storing a screenshot image is created according to the instruction “Bitmap bitmap = Bitmap.createBitmap(viewToCapture.getWidth(), viewToCapture.getHeight(), Bitmap.Config.ARGB_888”, and a Canvas object is created according to the instruction "Canvas canvas = new Canvas(bitmap)", and then the Bitmap object is used as its bitmap. Then the View to be captured is drawn onto the Canvas by using the instruction “viewToCapture.draw(canvas)”. Finally, the screenshot is saved to the album of the display apparatus 200 according to the instruction “MediaStore.Images.Media.insertImage(getContentResolver(), bitmap,"Screenshot", null); catch(FileNotFoundException e) e.printStackTrace()”.

In some embodiments, the display apparatus 200 may also extract a playback resumption image from a frame buffer of the casting interface, that is, the playback resumption image is an image frame extracted from the frame buffer of the casting interface according to the time corresponding to the media asset playback progress. For example, as shown in FIG. 11, the casting interface of the display apparatus 200 is a superimposed screen of the video layer and the graphics (On Screen Display, OSD) layer, that is, the image content of the casting interface may be rendered by a graphics processing unit (GPU) component, so as to form an image frame for display in the synthesis module. Here, the image frame may be stored in the synthesis module through the frame buffer and the video buffer, respectively, and the image content is formed in corresponding layers through a video process module. That is, the image frame corresponding to the cast screen during the casting process forms the image content through a video layer (video plane), and image frames of other image screens in the casting interface (such as controls, progress bars and other graphics of the UI interface) form the image content through the OSD layer (OSD plane). Finally, the display apparatus 200 forms a final image for display through a blending unit of the video process module. Therefore, the display apparatus 200 may extract the image frame of the final image at the time of inputting the exit command in the blending unit, or extract the image frame in the video buffer corresponding to the video layer as the playback resumption image.

In some embodiments, the display apparatus 200 may also directly obtain the playback resumption image through the data source of the casting data. For example, the display apparatus 200 may access the website link corresponding to the media asset playback address for a second time via a multimedia framework service (such as ffmpeg), and encapsulate it as getScaledFrameAtTime(time, option, width, height) to obtain a frame of thumbnail image corresponding to the media asset playback progress.

According to the method in the above embodiments, after the playback resumption information is generated, the display apparatus 200 may store the playback resumption information. In the process of storing the playback resumption information, the display apparatus 200 may construct a specific storage file format to save the playback resumption information. For example, the display apparatus 200 may construct a playback resumption information data table. In the playback resumption information data table, multiple table items may be included, namely the current media asset playback address, the media asset playback progress, the casting protocol type, the media asset title, and the playback effect information that can be manually set by the user. The playback effect information may include playback speed, audio track, subtitles, zoom mode, etc. Each table item may set a corresponding specific value according to the content of the recorded playback resumption information.

The playback resumption information may be stored in a specific storage area in the memory of the display apparatus 200, and the playback resumption information may be set to a state that can be called by the casting entry application or other applications. After the playback resumption information is stored, the display apparatus 200 may execute an exit command to exit a casting state, that is, the casting connection channel with the terminal device 500 is closed. After the casting connection channel between the display apparatus 200 and the terminal device 500 is closed, the display apparatus 200 may switch from displaying the casting interface to displaying other interfaces.

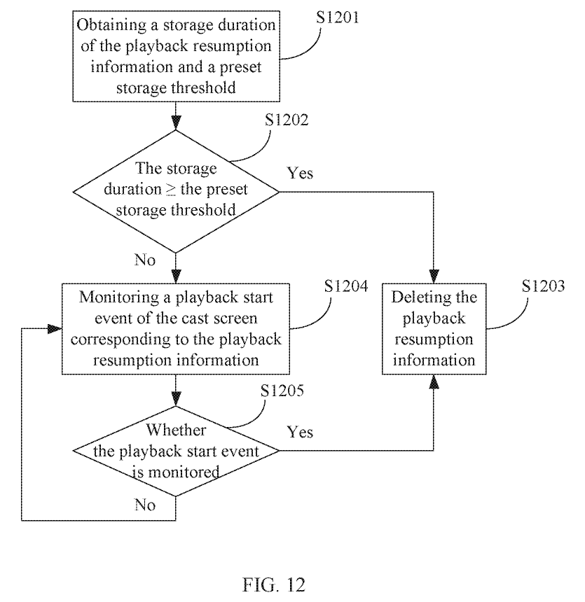

Since the playback resumption information is used for a user to perform a subsequent playback resumption operation of the cast screen, and the playback resumption operation is highly likely to occur in scenarios where the user reestablishes a casting connection within a short period after exiting the casting, the playback resumption information may also be stored according to a set duration. As shown in FIG. 12, the implementation may include the following steps.

S1201: obtaining a storage duration of the playback resumption information and a preset storage threshold.

S1202: determining whether the storage duration is greater than or equal to the preset storage threshold.

In response to the storage duration being greater than or equal to the preset storage threshold, S1203: deleting the playback resumption information.

For example, the preset storage threshold may be set to 24 hours based on an average interval duration for the display apparatus 200 to re-establish the casting connection after exiting the casting. After the playback resumption information is stored, the display apparatus 200 may record a storage duration of the playback resumption information. When the storage duration exceeds 24 hours, the display apparatus 200 may delete the playback resumption information. By setting the preset storage threshold, not only can the situation where the user can still see this entrance in the casting playback start interface for a long time be reduced, but also the storage space occupied by the playback resumption information can be reduced, thereby saving storage space. In addition, by actively clearing the playback resumption information regularly, the display apparatus 200 may also reduce the matching amount of the playback resumption information in the subsequent playback resumption process, so as to facilitate the quick completion of playback resumption.

In response to the storage duration being less than the preset storage threshold, S1204: monitoring a playback start event of the cast screen corresponding to the playback resumption information.

S1205: determining whether the playback start event is monitored; if the playback start event is monitored, jumping to the above step S1203, otherwise return to the above step S1204 to continue monitoring.

If the storage duration is less than the preset storage threshold, the display apparatus 200 may maintain the storage state of the playback resumption information. Obviously, when the display apparatus 200 has completed the playback resumption, the playback resumption information stored previously has no meaning to continue to be stored, that is, the display apparatus 200 may also monitor the playback start event of the cast screen corresponding to the playback resumption information, and delete the playback resumption information upon detecting the playback start event.

For example, the display apparatus 200 may monitor the playback start event of the cast screen during the existence of the playback resumption information. When it is monitored that the current cast screen has been resumed playing according to the playback resumption information, the display apparatus 200 may clear the playback resumption information, so that the playback progress after the playback resumption may also be recorded and stored, thereby achieving a continuous playback resumption effect.

In some embodiments, the display apparatus 200 may also monitor a casting connection operation of other terminal devices, and after monitoring that the display apparatus 200 establishes a casting connection with other terminal devices, the playback resumption information for resuming playing a cast screen corresponding to the original terminal device is cleared. For example, after the display apparatus 200 stores playback resumption information A of a cast screen corresponding to terminal A, during a validity period of the playback resumption information A, the display apparatus 200 may monitor a casting request from other terminal devices. When it monitors that the display apparatus 200 establishes a casting connection with terminal B, the display apparatus 200 may clear the playback resumption information A to prevent the original cast screen from still being resumable when a new cast screen is playing, affecting the user experience.

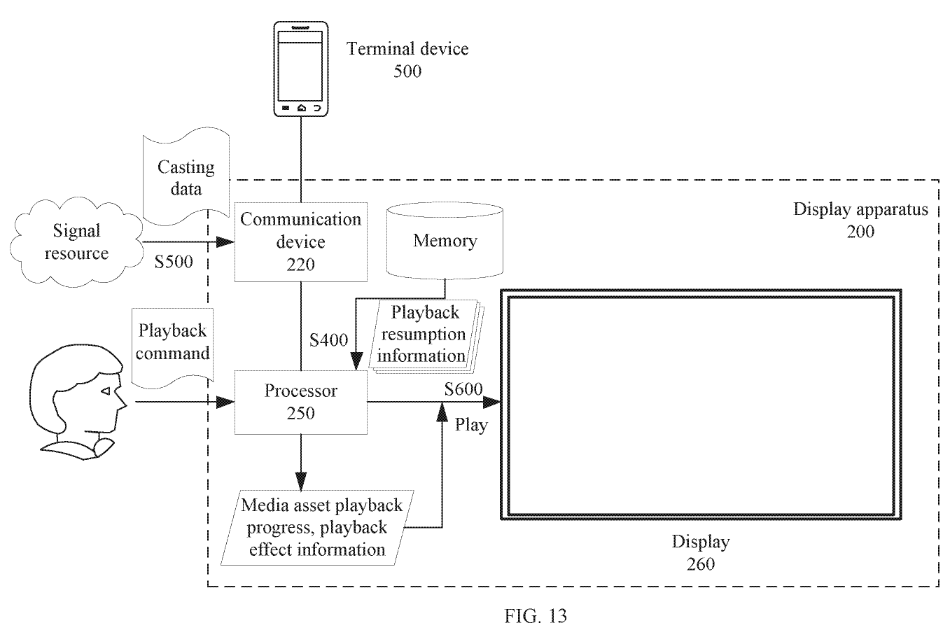

In the above steps S100 to S300, it is shown that the display apparatus 200 may record information such as the casting protocol type, the media asset playback address, and the media asset playback progress during the casting process when the casting interface is exited. The recorded information is saved in the form of playback resumption information, so that the display apparatus 200 may resume playing the cast screen based on the playback resumption information, as shown in FIG. 13.

S400: in response to a playback command for playing the cast screen, obtaining playback resumption information for resuming playing the cast screen.

After the display apparatus 200 stores the playback resumption information according to the method provided in the above embodiments, it may call the playback resumption information when playing the cast screen in the subsequent process and perform playback control based on the playback resumption information. The playback resumption information is the information recorded when a playback of the cast screen is exited, and the playback resumption information includes the casting protocol type, the media asset playback address, and the media asset playback progress.

That is, the display apparatus 200 may receive a playback command for playing the cast screen. The playback command may also be actively input by the user, or generated by the display apparatus 200 according to a judgment of its operating status. For the playback command input actively, the user may input a command based on the interactive operation methods such as the terminal device 500, a remote controller, touch, voice, etc. supported by the display apparatus 200. For example, the user may click a casting icon button in the upper right corner of the playback interface on the terminal device 500 to control the terminal device 500 to send a casting request to the display apparatus 200, i.e., input a playback command to the display apparatus 200.

For the playback command generated by the display apparatus 200, the display apparatus 200 may monitor its current operating state to determine whether the current state meets a preset playback condition, and generate a playback command when the preset playback conditions are met. For example, after exiting the casting interface, the display apparatus 200 may record an exit time of exiting the casting interface to determine an elapsed duration since the display apparatus 200 exited the casting interface. If the display apparatus 200 returns the casting interface within a preset return time, it may automatically generate a playback command.

It should be noted that the playback command generated by the display apparatus 200 should be conducive to the playback resumption of the cast screen and will not affect the user's normal casting operation. For example, when returning to the casting interface within a short time, the display apparatus 200 shall detect the casting connection after returning to the casting interface. After returning to the casting interface, if a terminal device 500 that establishes the casting connection with the display apparatus 200 is still the terminal device connected when the casting interface is exited, then the display apparatus 200 may automatically generate a playback command. After returning to the casting interface, if a terminal device 500 that establishes the casting connection with the display apparatus 200 is not the terminal device connected when the casting interface is exited, then the display apparatus 200 may detect a URL address of the current cast screen to determine whether the current cast screen is the original cast screen, and automatically generate a playback command when the URL address at the time of returning to the casting interface is the same as the URL address before exiting.

In order to facilitate the user to perform interactive operations, the display apparatus 200 may also provide a casting interactive interface. For example, the display apparatus 200 may call the casting entry application and obtain the playback resumption information for resuming playing the cast screen through the casting entry application, then control the casting entry application to generate a casting playback start interface according to the playback resumption information. Among them, the casting playback start interface includes at least one casting control, and the display content of the casting control is generated according to the playback resumption information.

After the casting entry application generates a casting playback start interface, the display apparatus 200 may control the display to display the casting playback start interface, and the user may input the playback command through at least one casting control in the casting playback start interface.

For example, after receiving the casting request sent by the terminal device 500, the display apparatus 200 obtains the playback resumption information for resuming playing the current cast screen. If the playback resumption information for resuming playing the cast screen is stored in the display apparatus 200, the casting entry application can be called to control the display apparatus 200 to display the casting playback start interface through the casting entry application.

The casting playback start interface may include casting options corresponding to the current cast screen. The casting options may be associated with a playback resumption control for the user to select. When the user clicks the playback resumption control, the display apparatus 200 may play the cast screen according to the playback resumption information. At the same time, the display apparatus 200 may also generate the playback command mentioned above.

For example, when the casting entry application is launched by the user through the remote controller, if there is thumbnail information in ContentProvider and there is a video title in Setting.Global, an action for initiating playback resumption is monitored, that is, whether the user clicks the playback resumption control in the casting playback start interface is detected. If there is no data, the display apparatus displays a casting entry interface, and after the user clicks the casting control, it navigates to a casting guide page to re-establish the casting connection.

S500: obtaining casting data from the media asset playback address through a virtual session.

After obtaining the playback resumption information in response to the playback command, the display apparatus 200 may parse the playback resumption information, thereby reading data such as the casting protocol type, the media asset playback address, and the media asset playback progress in the playback resumption information. The cast screen is then resumed based on the parsed data, that is, the display apparatus 200 may obtain the casting data from the media asset playback address and form a casting data stream for the player to play.

When the display apparatus 200 establishes a casting connection with the terminal device 500, the user needs to perform corresponding connection operation steps. For example, the user needs to first open a video playback interface through the terminal device 500, and then click a casting button in the video playback interface. Moreover, when the display apparatus 200 displays the casting playback start interface, the user also needs to click the playback resumption control in the casting playback start interface to complete the resumption operation, and there are many operation steps.

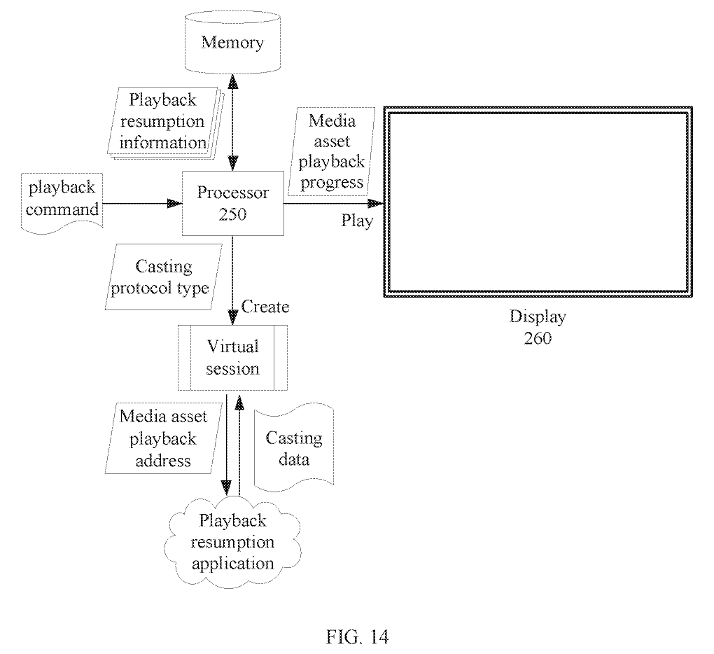

Therefore, in order to simplify user operations, in some embodiments, the display apparatus 200 may complete the casting connection through a virtual session instead of the terminal device 500. That is, as shown in FIG. 14, after obtaining the playback resumption information through the aforementioned process, the display apparatus 200 creates a virtual session based on the playback resumption information. The virtual session is used to, on behalf of the terminal device, establish a virtual casting connection with the display apparatus according to the casting protocol type.

In some embodiments, in order to create a virtual session based on the playback resumption information, the display apparatus 200 may also respond to a trigger indication of at least one casting control after detecting that the user clicks the at least one casting control on the casting playback start interface mentioned above, and determine a target casting control corresponding to the trigger indication. Then, the display apparatus may query a playback resumption application associated with the cast screen according to the target casting control. Next, the display apparatus may run the playback resumption application, and send the playback resumption information to the playback resumption application to control the playback resumption application to create the virtual session based on the playback resumption information. Here, the playback resumption application is an application used to form a cast screen.

For example, the display apparatus 200 may be configured with a fusion casting service. When the casting entry application sends an action message in response to a click operation of the user on the target casting control, the fusion casting service will monitor the action message and notify an adaptation layer of the playback resumption application to create a virtual session through the protocol type. Session may be used to store the properties and configuration information required for a specific user session. When the user navigates between application interfaces, variables stored in the session will not be lost, but will continue to exist throughout the user session. When a user request comes from the application interface, if the user does not have a session yet, the display apparatus 200 may automatically create a session. When the session expires or is abandoned, the display apparatus 200 will terminate the session.

In order to reduce the storage amount of the display apparatus about the playback resumption information, after the playback resumption information is generated through steps S100-S300, the playback resumption information may not be stored locally. Instead, part of the playback resumption information is stored in the casting control, and the remaining part of the playback resumption information is stored in the playback resumption application. For example, the media asset playback address, the playback effect information set by the user, etc. may be stored in the casting control, and the casting protocol type, the media asset playback progress, etc. may be stored in the playback resumption application. In this way, after determining the target casting control triggered by the user, the playback resumption information may be obtained from the target casting control and the playback resumption application corresponding to the target casting control.

The virtual session created by the display apparatus 200 may act on behalf of the terminal device 500 to establish a virtual casting connection with the display apparatus 200 according to the casting protocol type recorded in the playback resumption information, so that the display apparatus 200 does not need to repeatedly re-establish the casting connection with the terminal device 500, but directly uses the media asset playback address recorded in the playback resumption information to obtain the casting data. That is, the casting data is obtained from the media asset playback address through the virtual session.

In some embodiments, the virtual session may also be used to obtain playback resumption information, and use the playback resumption information as a control variable in the playback process for use by the player of the display apparatus 200. That is, the adaptation layer of the playback resumption application creates a virtual Session upon receiving a playback resumption message and obtains the saved playback resumption information.

S600: determining a playback start time for the casting data according to the media asset playback progress, and playing the casting data from the playback start time based on the playback effect information.

After obtaining the casting data, the display apparatus 200 may input the casting data into the player, and the player performs playback operations such as decoding, rendering, and outputting the picture on the casting data to form a cast screen. Meanwhile, the display apparatus 200 may send the media asset playback progress and the playback effect information manually set by the user in the playback resumption information to the player, so that the player determines the playback start time for the casting data according to the media asset playback progress, and plays the casting data from the playback start time according to an effect (such as the playback speed, audio track, and subtitles of the video mentioned above) configured in the playback effect information.

For example, a playback progress of media asset A: 0:38:25, speed: 1.2x, subtitles: disabled, and other playback effect information may be recorded in the playback resumption information obtained by the display apparatus 200. Then, the display apparatus 200 may obtain a data stream from a playback address of media asset A at 0:38:25, and input the obtained data stream into the player. Then, the player may decode and render the media asset data from 0:38:25 onwards, and output the image to the display 260, so that the display 260 plays the cast screen from 0:38:25 at a playback speed of 1.2x.

In the above-mentioned embodiments, when casting is performed in the push mode, by recording the playback resumption information and invoking the recorded playback resumption information when playing the cast screen, the display apparatus 200 may play the casting data according to the media asset playback progress in the playback resumption information, thereby achieving the casting resumption effect.

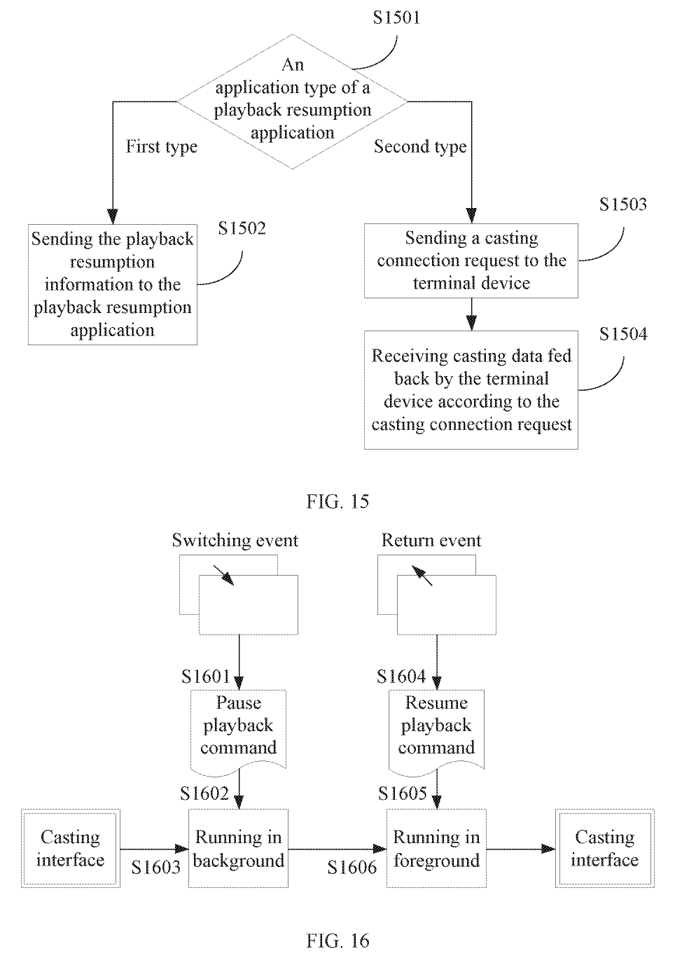

Since different display apparatus 200 support different casting modes, functions available after establishing a corresponding casting connection are also different. For example, when the display apparatus 200 establishes a casting connection through a video application, different video applications have varying levels of support for a playback resumption function, For example, for a system video application of the display apparatus 200 and a video application developed by the third-party application provider that has a cooperative relationship with the operator of the display apparatus 200, the playback resumption information may be recorded and retrieved according to cooperation specifications. However, a third-party video application without such a cooperative relationship does not support a casting playback resumption function, because it does not have a corresponding built-in algorithm for recording and retrieving the playback resumption information, Based on this, the display apparatus of the embodiments of the present disclosure may further implement casting playback resumption according to the application type. As shown in FIG. 15, the implementation process includes the following steps.

S1501: determining an application type of a playback resumption application.

The application type may include a first type that supports casting playback resumption or a second type that does not support casting playback resumption. During implementation, the application package name information may be read to obtain an application name, a developer and other description information, and the application type of the application may be determined by matching the application package name information with a preset matching table.

For example, if the developer of application A is the operator of display apparatus 200, that is, application A is the system application of display apparatus 200, then it can be determined that application A supports the casting playback resumption function, that is, the application type of application A is categorized as the first type. Correspondingly, if it is determined by retrieving the application package name information that the developer of application B is not the operator of display apparatus 200, and the developer of application B does not have a cooperative relationship with the operator of display apparatus 200, it can be concluded that application B does not support the casting playback resumption function, that is, the application type of application B is categorized as the second type.

S1502: in response to the application type being the first type, sending the playback resumption information to the playback resumption application.

S1503: in response to the application type being the second type, sending a casting connection request to the terminal device.

S1504: receiving casting data fed back by the terminal device according to the casting connection request.

If the application type is the second type, it means that the playback resumption application does not support the casting playback resumption function. At this time, a casting connection request may be sent to the terminal device 500, and the casting data fed back by the terminal device 500 according to the casting connection request may be received. That is, when the display apparatus 200 determines that the playback resumption application does not support casting playback resumption by using the recorded playback resumption information, it may resend a casting connection request to the terminal device 500 to re-establish the casting connection.

In order to realize a playback resumption function, as shown in FIG. 16, the display apparatus 200 may also monitor a switching event of the casting interface when determining that the application type of the playback resumption application is the second type (S1601). The switching event refers to an event that triggers the display apparatus 200 to switch from displaying the casting interface to displaying other interfaces, which may be triggered by an exit command or by other conditional judgment methods.

Upon monitoring the switching event, the display apparatus 200 may generate a pause playback command in response to the switching event (S1602). The pause playback command is configured to pause the playback of the casting data corresponding to the cast screen. That is, the display apparatus 200 may control the cast screen to pause through the pause playback command, and switch the casting interface to run in a background (S1603). The display apparatus 200 adopts different ways to implement playback pause for different casting modes. When the casting connection is established in the push mode, the playback process is executed by the player of the display apparatus 200. Then, the display apparatus 200 may directly respond to the pause playback command after the pause playback command is generated to pause the playback process of the casting data. When the casting connection is established in the mirroring mode, since the playback process is not executed by the player of the display apparatus 200, but by the terminal device 500, it is possible to send a pause playback command to the terminal device 500 after the pause playback command is generated, so that the terminal device 500 responds to the pause playback command and pauses the playback process of the casting data.

After switching the casting interface to run in the background, the display apparatus 200 may monitor a return event of the casting interface within a preset time duration (S1604). After monitoring the return event, the display apparatus 200 responds to the return event and generates a resume playback command (S1605), that is, to resume playing the casting data corresponding to the cast screen, and control the display 260 to display the casting interface (S1606).

It can be seen that in the above embodiments, the display apparatus 200 may adopt different ways to realize casting playback resumption according to the application type of the playback resumption application, so that the display apparatus 200 may adapt to more types of playback resumption applications to solve the problem that the casting playback process cannot be resumed.

Based on the above-mentioned display apparatus 200, the embodiments of the present disclosure also provides a method for resuming playing a cast screen, including: in response to a playback command for playing a cast screen, obtaining playback resumption information for resuming playing the cast screen, the playback resumption information being information recorded when the playback of the cast screen is exited, the playback resumption information including the casting protocol type, the media asset playback address, the media asset playback progress, and the playback effect information set by a user; creating a virtual session based on the playback resumption information, the virtual session being used to, on behalf of the terminal device, establish a virtual casting connection with the display apparatus according to the casting protocol type; obtaining casting data from the media asset playback address through the virtual session; determining the playback start time for the casting data according to the media asset playback progress, and playing the casting data from the playback start time based on the playback effect information.

From the above process, it can be seen that this method may record the playback resumption information when the display apparatus cuts out the casting interface, and it supports the display apparatus to obtain the playback resumption information saved previously when returning to the casting interface, and jump to the corresponding media asset playback progress according to the playback resumption information, thereby achieving the playback resumption of the cast screen and solving the problem of inability to resume playback during the casting process.

What is claimed is:

1. A display apparatus, comprising:
a display, configured to display a casting interface for a cast screen;
a user input interface, configured to receive commands from a user;
a communication device, configured to establish a casting connection with a terminal device;
a memory, configured to store computer instructions and data associated with the display apparatus;
at least one processor, connected with the display, the user input interface, the communication device and the memory, and configured to execute the computer instructions to cause the display apparatus to perform:
in response to a resume playback command for playing a cast screen exited last time, obtaining playback resumption information of the cast screen from the memory; wherein the playback resumption information is information recorded when a playback of the cast screen was exited last time, and the playback resumption information comprises a casting protocol type, a media asset playback address, media asset playback progress at a time the cast screen was exited last time, and playback effect information set for the cast screen by the user;
creating a virtual session based on the playback resumption information; wherein the virtual session is configured to, on behalf of the terminal device that established a casting connection for the cast screen that was exited last time, establish a virtual casting connection with the display apparatus according to the casting protocol type;
obtaining casting data from the media asset playback address through the virtual session without re-establishing a physical casting connection with the terminal device;
determining a playback start time for the casting data according to the media asset playback progress, and playing the casting data on the display from the playback start time based on the playback effect information.

2. The display apparatus according to claim 1, wherein the at least one processor is further configured to execute the computer instructions to cause the display apparatus to perform:
obtaining an exit command for exiting the casting interface during the playback of the cast screen;
in response to the exit command, recording the casting protocol type and the media asset playback address corresponding to the casting interface, media asset playback progress at a moment when the exit command is input, and the playback effect information set for the cast screen by the user;
generating the playback resumption information according to the casting protocol type, the media asset playback address, the media asset playback progress, and the playback effect information;
storing the playback resumption information in the memory, and closing a physical casting connection established with the terminal device for the cast screen.

3. The display apparatus according to claim 2, wherein the at least one processor is further configured to execute the computer instructions to cause the display apparatus to perform:
before storing the playback resumption information in the memory, generating a playback resumption image according to the media asset playback address and the media asset playback progress;
performing a compression processing on the playback resumption image to generate a thumbnail; and
adding the thumbnail to the playback resumption information, and storing updated playback resumption information in the memory.

4. The display apparatus according to claim 3, wherein the playback resumption image comprises:
an image frame extracted from a data stream of the cast screen according to the media asset playback progress at the moment when the exit command is input; or,
an image obtained by invoking a screenshot interface to capture the cast screen at the moment when the exit command is input.

5. The display apparatus according to claim 3, wherein the at least one processor is further configured to execute the computer instructions to cause the display apparatus to manage the playback resumption image by:
after storing the playback resumption information in the memory, obtaining a storage duration of the playback resumption information and a preset storage threshold;
in response to the storage duration being greater than or equal to the preset storage threshold, deleting the playback resumption information from the memory;
in response to the storage duration being less than the preset storage threshold, monitoring a playback start event of the cast screen corresponding to the playback resumption information, and deleting the playback resumption information from the memory upon detecting the playback start event.

6. The display apparatus according to claim 2, wherein the at least one processor is further configured to execute the computer instructions to cause the display apparatus to perform:
after recording the media asset playback address, the media asset playback progress at the moment when the exit command is input, and the playback effect information, obtaining a total duration of a media asset of the cast screen;
calculating a remaining duration of the media asset according to the total duration of the media asset and the media asset playback progress at the moment when the exit command is input;
in response to the remaining duration of the media asset being greater than or equal to a preset duration threshold, generating and storing the playback resumption information;
in response to the remaining duration of the media asset being less than the preset duration threshold, directly closing the physical casting connection with the terminal device.

7. The display apparatus according to claim 1, wherein the playback effect information comprises at least one of following items set by the user for the cast screen:
a playback speed, an audio track, a subtitle setting, or a screen zoom mode.

8. The display apparatus according to claim 1, wherein the at least one processor is configured to execute the computer instructions to cause the display apparatus to receive the playback command by:
calling a casting entry application, wherein the casting entry application is configured as an application that provides a casting playback start interface;
obtaining the playback resumption information of the cast screen from the memory through the casting entry application;
controlling the casting entry application to generate the casting playback start interface according to the playback resumption information, wherein the casting playback start interface comprises at least one casting control, and display content of the at least one casting control is generated according to the playback resumption information;
controlling the display to display the casting playback start interface, and receiving a resume playback command triggered by the user via the at least one casting control on the casting playback start interface.

9. The display apparatus according to claim 8, wherein the display content of the at least one casting control comprises at least one of:
a thumbnail of the cast screen,
a title of a media asset of the cast screen, or,
the media asset playback progress at the time the cast screen was exited last time.

10. The display apparatus according to claim 8, wherein the at least one processor is configured to execute the computer instructions to cause the display apparatus to perform said creating of the virtual session based on the playback resumption information by:
in response to a trigger indication on the at least one casting control, determining a target casting control corresponding to the trigger indication;
querying a playback resumption application associated with the cast screen according to the target casting control, wherein the playback resumption application is an application used to form the cast screen on the display apparatus;
running the playback resumption application, and sending the playback resumption information to the playback resumption application;
controlling the playback resumption application to create the virtual session based on the playback resumption information.

11. The display apparatus according to claim 10, wherein the at least one processor is further configured to execute the computer instructions to cause the display apparatus to perform:
detecting an application type of the playback resumption application, wherein the application type is a first type that supports casting playback resumption or a second type that does not support casting playback resumption;
in response to the playback resumption application being of the first type, maintaining an operation of the playback resumption application creating the virtual session to the obtain casting data;
in response to the playback resumption application being of the second type, triggering the communication device to send a casting connection request to the terminal device, and receiving casting data fed back by the terminal device according to the casting connection request.

12. The display apparatus according to claim 11, wherein the at least one processor is further configured to, based on the playback resumption application being of the second type, execute the computer instructions to cause the display apparatus to perform:
monitoring a switching event of the casting interface;
in response to the switching event, generating a pause playback command, wherein the pause playback command is configured to pause a playback of the casting data corresponding to the cast screen;
switching the casting interface to run in a background;
monitoring a return event of the casting interface within a preset time duration;
in response to the return event, generating the resume playback command, controlling the display to redisplay the casting interface and to resume the playback of the casting data according to the resume playback command.

13. The display apparatus according to claim 1, wherein the casting protocol type comprises at least one of a DLNA protocol, a Miracast protocol, an AirPlay protocol, or a WiDi protocol.

14. The display apparatus according to claim 1, wherein the media asset playback progress is expressed by a playback time point of a media asset of the cast screen or by a playback percentage relative to a total duration of the media asset.

15. The display apparatus according to claim 1, wherein the virtual session is further configured to obtain access permission to the media asset playback address on behalf of the terminal device; wherein the display apparatus obtains the casting data from the media asset playback address by virtue of the access permission.

16. A method for resuming playing a cast screen, comprising:
in response to a resume playback command for playing a cast screen exited last time, obtaining playback resumption information of the cast screen; wherein the playback resumption information is information recorded when a playback of the cast screen was exited last time, and the playback resumption information comprises a casting protocol type, a media asset playback address, media asset playback progress at a time the cast screen was exited last time, and playback effect information set for the cast screen by the user;
creating a virtual session based on the playback resumption information; wherein the virtual session is configured to, on behalf of a terminal device that established a casting connection for the cast screen exited last time, establish a virtual casting connection with the display apparatus according to the casting protocol type;
obtaining casting data from the media asset playback address through the virtual session without re-establishing a physical casting connection with the terminal device;
determining a playback start time for the casting data according to the media asset playback progress, and playing the casting data on the display from the playback start time based on the playback effect information.

17. The method according to claim 16, further comprising:
obtaining an exit command for exiting the casting interface during the playback of the cast screen;
in response to the exit command, recording the casting protocol type and the media asset playback address corresponding to the casting interface, media asset playback progress at a moment when the exit command is input, and the playback effect information set for the cast screen by the user;
generating the playback resumption information according to the casting protocol type, the media asset playback address, the media asset playback progress, and the playback effect information;
storing the playback resumption information in the memory, and closing a physical casting connection established with the terminal device for the cast screen.

18. The method according to claim 17, further comprising:
before storing the playback resumption information in the memory, generating a playback resumption image according to the media asset playback address and the media asset playback progress;
performing a compression processing on the playback resumption image to generate a thumbnail; and
adding the thumbnail to the playback resumption information, and storing updated playback resumption information in the memory.

19. The method according to claim 18, further comprising:
after storing the playback resumption information in the memory, obtaining a storage duration of the playback resumption information and a preset storage threshold;
in response to the storage duration being greater than or equal to the preset storage threshold, deleting the playback resumption information from the memory;
in response to the storage duration being less than the preset storage threshold, monitoring a playback start event of the cast screen corresponding to the playback resumption information, and deleting the playback resumption information from the memory upon detecting the playback start event.

20. The method according to claim 17, further comprising:
after recording the media asset playback address, the media asset playback progress at the moment when the exit command is input, and the playback effect information, obtaining a total duration of a media asset of the cast screen;
calculating a remaining duration of the media asset according to the total duration of the media asset and the media asset playback progress at the moment when the exit command is input;
in response to the remaining duration of the media asset being greater than or equal to a preset duration threshold, generating and storing the playback resumption information;
in response to the remaining duration of the media asset being less than the preset duration threshold, directly closing the physical casting connection with the terminal device.
